(19) United States
(12) Patent Application Publication
(10) Pub. No.: US 2006/0142415 A1
(43) Pub. Date: Jun. 29, 2006

(54) Method of making and using inkjet inks

(75) Inventors: Caroline M. Ylitalo, Stillwater, MN (US); Richard L. Severance, Stillwater, MN (US); Ronald K. Thery, New Brighton, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/269,485

(22) Filed: Nov. 8, 2005

Related U.S. Application Data
(60) Provisional application No. 60/640,138, filed on Dec. 29, 2004.

(51) Int. Cl. C03C 17/00; C08F 2/50

(52) U.S. Cl. 523/160; 522/6

(57) ABSTRACT

Disclosed herein is a method of making an inkjet ink, comprising milling a pigment in an organic solvent to form a millbase, wherein the millbase is substantially free of polymerizable components; and mixing a polymerizable composition with the millbase to form a polymerizable ink.

### CROSS REFERENCE TO RELATED APPLICATION

This application claims priority from US Provisional Application Ser. No. 60/640,138 by Ylitalo et al., entitled “Method of Making and Using Inkjet Inks”, filed Dec. 29, 2004.

### FIELD OF THE INVENTION

Disclosed herein is a method of making and using inkjet inks, specifically, inkjet inks that are polymerizable.

### BACKGROUND

Inkjet imaging techniques have become popular in commercial and consumer applications. Inkjet printers operate by ejecting ink onto a substrate in controlled patterns of closely spaced ink droplets. By selectively regulating the pattern of ink droplets, inkjet printers can produce a wide variety of printed features, including text, graphics, images, holograms, and the like. Moreover, inkjet printers are capable of forming printed features on a wide variety of substrates, as well as three-dimensional objects in applications such as rapid prototyping.

### SUMMARY

Disclosed herein is a method of making an inkjet ink, comprising milling a pigment in an organic solvent to form a millbase, wherein the millbase is substantially free of polymerizable components; and mixing a polymerizable composition with the millbase to form a polymerizable ink. The inkjet inks generally include a polymerizable component comprising one or more monomers and/or one or more oligomers.

The method facilitates the manufacture of inkjet inks because a single millbase may be used to form a variety of inks having different polymerizable components. This is especially desirable because specialized milling equipment is expensive and clean-up time is minimized. The inkjet inks prepared as described herein exhibit low viscosity, printability, wettability, compatibility and rapid polymerization. Images printed using the inkjet inks show high dot-gain and gloss. The inkjet inks made according to the methods disclosed herein are suitable for forming ink-jetted, polymerized printed features on a substrate, such as a sign. Features include text, bar codes, graphics, images and/or other indicia. The inkjet inks are suitable for outdoor use.

### DETAILED DESCRIPTION

For the purpose of the present application, the following terms are defined herein.
“Monomer” means a relatively low molecular weight, for example a molecular weight less than about 500 g/mole, material having one or more polymerizable groups.
“Oligomer” means a relatively intermediate molecular weight, for example a molecular weight of from 500 up to about 100,000 g/mole, material having one or more polymerizable groups.
“Molecular weight” as used throughout this specification means number average molecular weight unless expressly noted otherwise.
“Polymerizable” refers to groups that can participate in polymerization in the presence of an initiator and upon activation of the initiator using actinic radiation. The polymerizable groups may form polymer backbone upon polymerization, or the polymerizable groups may be pendant groups of monomer, oligomer, or some combination thereof.
“Polymerizable components” means one or more monomers and/or one or more oligomers.
“Polymerizable composition” means a composition comprising polymerizable components.
“Polymerizable composition” means a polymerizable composition that undergoes polymerization upon exposure to actinic radiation.
“Substantially free of polymerizable components” means that the millbase contains less than about 10 percent by weight of polymerizable components.
“Dot gain” means radial diffusion of the individual ink drops on the surface of the printed substrate.
“(Meth)acrylic” and other such terms refers to methacrylic and acrylic.

Disclosed herein is a method of making an inkjet ink, comprising milling a pigment in an organic solvent to form a millbase, wherein the millbase is substantially free of polymerizable components; and mixing a polymerizable composition with the millbase to form a polymerizable ink.

Generally, polymerizable components and compositions tend to increase the viscosity of an inkjet ink. Many polymerizable components are monomers and oligomers which tend to have a higher viscosity than organic solvents. In addition, polymerizable compositions tend to have monomers and/or oligomers which have pendant polymerizable groups which tend to be polar groups that increase viscosity. So generally, inkjet inks formed with polymerizable components tend to have higher viscosities than otherwise identical inks in which some of the polymerizable components have been replaced with organic solvent. The use of organic solvent in the millbase allows for a higher pigment loading in the millbase and subsequently in the ink, because the final ink contains less polymerizable components and more organic solvent. When such inks are printed, they yield features or images showing high color saturation.

By using a limited amount of organic solvent, the organic solvent is easily removed to provide organic solvent free inkjetted features. The organic solvent may be removed using the heat generated by the radiation source such that removal and polymerization occur substantially in the same printing step. If this is done, polymerization rates of the polymerizable components may increase, presumably because the vapors of the organic solvent form a barrier over the printed ink, and thus slow down inhibition by ambient oxygen. Carrying out removal of organic solvent and polymerization in the same step, as opposed to separate steps, may aid production speeds such that at least 93 m²/hr (1000 ft²/hr) may be achieved.

When the method for making an inkjet ink as described above is used, the millbase may also be used to make organic solvent-based inkjet inks without the need to manufacture two different millbases. As used herein, organic solvent-based inkjet inks comprise at least about 60 percent by weight of organic solvent. Therefore, inventories are reduced (one millbase per color instead of two) and manufacturing logistics become easier. Only one type of millbase need be made using expensive specialized milling equipment, and clean-up time is reduced.

Inkjet inks made by the method disclosed herein may have a viscosity less than about 50 cP at 25° C. Inkjet inks made by the method disclosed herein may have a viscosity less than about 30 cP at 25° C. In some applications, the inkjet inks made by the method disclosed herein may have a viscosity less than about 20 cP at the inkjetting temperature. In general, the viscosity of the inkjet inks disclosed herein may vary depending on the inkjetting temperature and the type of inkjet printhead and/or system being used. For example, for inkjet applications using a piezoelectric inkjet printhead, a typical desired viscosity is 3 to 30 cP at the printhead temperature; or a viscosity of 10 to 50 cP at 25° C. In particular, the inkjet inks may have a viscosity of from about 10 to about 16 cP at 25° C. to 65° C. The viscosity used should be such that the inkjet inks will be jettable over long periods of time. The printhead temperature is desirably no higher than 65° C. in order to minimize any polymerization in the printhead.

Inkjet inks made by the method disclosed herein may have a surface tension of from about 20 mN/m to about 50 mN/m. Inkjet inks made by the method disclosed herein may have a surface tension of less than about 30 mN/m. Inkjet inks made by the method disclosed herein may have a surface tension of from about 22 mN/m to 40 mN/m at the printhead temperature. Generally, inkjet inks made by the method disclosed herein have Newtonian or substantially Newtonian viscosity properties. Newtonian viscosity properties mean that the viscosity is largely independent of shear rate and has a power law index of 0.95 or greater. The power law index, n, is given by the expression: η=mγⁿ⁻¹ wherein η is the shear viscosity, y is the shear rate in s⁻¹, and m is a constant. The principles of the power law index are further described in C. W. Macosko, “Rheology: Principles, Measurements, and Applications”, ISBN # 1-56081-579-5, page 85. Having a Newtonian viscosity presumably facilitates ink flow into the inkjet printhead from the bulk ink supply. In addition, the organic solvent may have a surface tension at least 2 mN/m less than the surface tension of the polymerizable composition.

Inkjet inks made by the method disclosed herein comprise at least one pigment as the colorant. Suitable pigments may be organic or inorganic. Examples of inorganic pigments include carbon black and titanium oxide. Examples of organic pigments include phthalocyanines, anthraquinones, perylenes, carbazoles, monoazo- and disazobenzimidazolones, isoindolinones, monoazonaphthosl, diarylidepyrazolones, rhodamines, indigoids, quinacridones, diazopyranthrones, dinitranilines, pyrazolones, dianisidines, pyranthrones, tetrachloroisoindolinones, dioxazines, monoazoacrylides, and anthrapyrimidines.

Commercial examples of organic pigments include those described in The Colour Index, Vols. 1-8, Society of Dyers and Colourists, Yorkshire, England; including, for example Pigment Blue 1, Pigment Blue 15, Pigment Blue 15:1, Pigment Blue 15:2, Pigment Blue 15:3, Pigment Blue 15:4, Pigment Blue 15:6, Pigment Blue 16, Pigment Blue 24, and Pigment Blue 60 (blue pigments); Pigment Brown 5, Pigment Brown 23, and Pigment Brown 25 (brown pigments); Pigment Yellow 3, Pigment Yellow 14, Pigment Yellow 16, Pigment Yellow 17, Pigment Yellow 24, Pigment Yellow 65, Pigment Yellow 73, Pigment Yellow 74, Pigment Yellow 83, Pigment Yellow 95, Pigment Yellow 97, Pigment Yellow 108, Pigment Yellow 109, Pigment Yellow 110, 5 Pigment Yellow 113, Pigment Yellow 128, Pigment Yellow 129, Pigment Yellow 138, Pigment Yellow 139, Pigment Yellow 150, Pigment Yellow 154, Pigment Yellow 156, and Pigment Yellow 175 (yellow pigments); Pigment Green 1, Pigment Green 7, Pigment Green 10, and Pigment Green 36 (green pigments); Pigment Orange 5, Pigment Orange 15, Pigment Orange 16, Pigment Orange 31, Pigment Orange 34, Pigment Orange 36, Pigment Orange 43, Pigment Orange 48, Pigment Orange 51, Pigment Orange 60, and Pigment Orange 61 (orange pigments); Pigment Red 4, Pigment Red 5, Pigment Red 7, Pigment Red 9, Pigment Red 22, Pigment Red 23, Pigment Red 48, Pigment Red 48:2, Pigment Red 49, Pigment Red 112, Pigment Red 122, Pigment Red 123, Pigment Red 149, Pigment Red 166, Pigment Red 168, Pigment Red 170, Pigment Red 177, Pigment 15 Red 179, Pigment Red 190, Pigment Red 202, Pigment Red 206, Pigment Red 207, and Pigment Red 224 (red pigments); Pigment Violet 19, Pigment Violet 23, Pigment Violet 37, Pigment Violet 32, and Pigment Violet 42 (violet pigments); and Pigment Black 6 or 7 (black pigments).

To make a millbase from the pigment, a dispersant for the pigment may be used in order to stabilize the pigment. The choice of dispersant used depends on factors such as the type of pigment used, the particular organic solvent or solvents, other pigments incorporated into the millbase, as well as the polymerizable composition and other components. Mixtures of dispersants may also be used. Examples of commercially available dispersants are sold under the trade designations SOLSPERSE from Zeneca of Wilmington, Del.; EFKA from Lubrizol Corp. of Wickliff, Ohio; and BYK from BYK-Chemie USA of Wallingford, Conn. The amount of dispersant used depends on the type and concentration of the pigment. Typically, 20 to 100 percent by weight of dispersant per 100 percent by weight of organic pigment are used. Typically, 5 to 80 percent by weight of the dispersant per 100 percent by weight of inorganic pigment are used.

A wide range of organic solvents include alcohols such as isopropyl alcohol and ethanol; ketones such as methyl ethyl ketone, cyclohexanone, and acetone; aromatic hydrocarbons; isophorone; butyrolactone; N-methyl pyrrolidone; tetrahydrofuran; ethers such as lactates and acetates; alkylene glycol esters such as propylene glycol monomethyl ether acetate, diethylene glycol ethyl ether acetate, ethylene glycol butyl ether acetate, dipropylene glycol mono methyl acetate, and isoalkyl esters such as isohexyl acetate, isoheptyl acetate, isooctyl acetate, isononyl acetate, isodecyl acetate, isododecyl acetate, and isotridecyl acetate. Isoalkyl esters, or branched aliphatic esters, are especially useful as organic solvents because they tend to provide stable millbases, and they have high flash points yet evaporate easily during polymerization of the ink during printing, are good solvents for the polymerizable components and polymers if used. Isoalkyl esters provide good image quality and dot gain when printed, especially on nonporous substrates as described below. A particular example are those available under the trade designation EXXATE from ExxonMobil Corp. of Irving, Tex. The organic solvent may comprise one or more isoalkyl esters selected from the group consisting of isohexyl acetate, isoheptyl acetate, isooctyl acetate, isononyl acetate, isodecyl acetate, isododecyl acetate, and isotridecyl acetate. The organic solvent may comprise an ether. The organic solvent may be a nonpolar organic solvent rather than a polar organic solvent such as isopropyl alcohol. Nonpolar organic solvents do not tend to have an affinity for the dispersants, if any, used to stabilize the pigment in the inks. This affinity can cause pigment agglomeration and ink destabilization.

The amount of organic solvent used in the millbase should be enough to promote the desired level of wetting and adhesion when the ink is printed on a substrate, and to reduce the viscosity and surface tension to levels described above. In general, using lesser amounts of organic solvent tends to provide better quality printed features as compared to using greater amounts of organic solvent. Using more organic solvent than is needed may also increase the difficulty of removal during printing which could deteriorate image quality. As general guidelines, the ink may comprise 0.1 to 40, for example 0.5 to 15,or 1 to 10, percent by weight of the organic solvent. The inkjet ink may comprise organic solvent in an amount of less than about 15 percent by weight, relative to the total weight of the inkjet ink. The inkjet ink may comprise organic solvent in an amount of less than about 12 percent by weight, relative to the total weight of the inkjet ink.

Organic solvents used in the method disclosed herein may have a surface tension of from about 20 mN/m to about 50 mN/m. In some cases, it is useful for the organic solvent to have a surface tension at least 2 mN/m less than the surface tension of the polymerizable composition. Generally, the organic solvent may have a surface tension that is less than about 30 mN/m at 25° C., for example less than about 28 mN/m at 25° C., and less than about 26 mN/m at 25° C. The organic solvents also may have a relatively high flash point of at least about 50° C., for example at least about 60° C.

In the method disclosed herein, the pigment is milled in the organic solvent. A mixture is prepared by combining from 1 to 80 percent by weight of the pigment with the balance being organic solvent. If needed, a dispersant for the pigment is added. At this stage, the pigment may be incorporated into the dispersion as supplied by the vendor. Milling will reduce the pigment size to the desired fine particle size. This initial dispersion may be prepared by first predissolving one or more dispersants in the organic solvent and then adding the desired amount of pigment powder. Initial wetting of the pigment is accomplished with high shear mixing. Next, the dispersion is subjected to high energy milling techniques such as ball milling, sand milling, horizontal media milling, attritor milling, or 2- or 3-roll milling, or the like in order to reduce the pigment to the desired particle size. Detailed teaching of pigment milling and millbase let down can be found in Patton, “Paint Flow and Pigment Dispersion”, ISBN #0-471-03272. The resulting millbase is desirably stable in that it appears to remain homogeneous and the particle size does not increase over long periods of time, for example, 26 weeks. Following the milling procedure, the pigment dispersion may be diluted with organic solvent.

In the method disclosed herein, the millbase is substantially free of polymerizable components, i.e., the millbase contains less than about 10% by weight of polymerizable components. The millbase may be less than 1 percent by weight, and even 0 percent by weight, of polymerizable components.

The pigment particle size is desirably less than 5 micrometers, for example less than 1 micrometer, and in specific examples less than 0.5 micrometers. In applications requiring transparency, such as for printing on retroreflective sheeting, the pigment must be milled to a particle size that provides sufficient transparency to permit retroreflection and provide retroreflective color. The particle size of the pigment colorant may be characterized by an appropriate method such as dynamic light scattering (DLS) or microscopy.

The resulting millbase is then diluted to the desired color strength (tint strength) using the polymerizable composition, thereby fixing the organic solvent concentration in the ink. However, optionally the organic solvent concentration in the ink can be increased if desired by incorporating further organic solvent when adding the polymerizable composition.

It will be appreciated that a number of methods can be used to add the polymerizable composition to the millbase. For example, mixing the polymerizable composition with the millbase can be done by premixing all of the polymerizable composition components to form a premix, and then mixing the polymerizable composition premix and the millbase. Or mixing the polymerizable composition with the millbase can be done by mixing some or all of the polymerizable composition components to form one or more premixes, and then mixing the premix or premixes and any other individual components with the millbase to make the ink. Or the step of mixing the polymerizable composition with the millbase can be accomplished by adding polymerizable composition components individually to the millbase to form the ink. These steps can be performed in any combination or order. Although the millbase comprises an organic solvent, the same or different organic organic solvent may be one of the components of the polymerizable composition.

The polymerizable composition comprises one or more monomers and/or one or more oligomers. The one or more monomers and/or the one or more oligomers may be polymerizable by addition polymerization.

In general, the one or more monomers may be selected from the group consisting of styrenes, vinyls, (meth)acrylamides, (meth)acrylates, epoxides, (meth)acrylonitriles, and unsaturated anhydrides. For example, the one or more monomers may be styrene, alpha-methyl styrene, substituted styrene, vinyl esters, vinyl ethers, N-vinyl-2- pyrrolidone, (meth)acrylamide, N-substituted (meth)acrylamide, octyl(meth)acrylate, nonylphenol ethoxylate(meth)acrylate, isononyl(meth)acrylate, isobornyl(meth)acrylate,2-(2-ethoxyethoxy)ethyl(meth)acrylate, 2ethylhexyl (meth)acrylate, lauryl (meth)acrylate, P-carboxyethyl(meth)acrylate, isobutyl(meth)acrylate, cycloaliphatic epoxide, 2-hydroxyethyl(meth)acrylate, (meth)acrylonitrile, maleic anhydride, itaconic acid, isodecyl(meth)acrylate, dodecyl(meth)acrylate, n-butyl(meth)acrylate, methyl(meth)acrylate, hexyl(meth)acrylate, (meth)acrylic acid, N-vinylcaprolactam, stearyl(meth)acrylate, hydroxy functional caprolactone ester(meth)acrylate, isooctyl(meth)acrylate, hydroxyethyl(meth)acrylate, hydroxymethyl(meth)acrylate, hydroxypropyl(meth)acrylate, hydroxyisopropyl(meth)acrylate, hydroxy butyl(meth)acrylate, hydroxyisobutyl(meth)acrylate, tetrahydrofurfuryl(meth)acrylate, or a combination thereof.

As general guidelines, the polymerizable composition may comprise from 25 to 100, for example 40 to 90 percent by weight of the one or more monomers.

In general, the one or more oligomers may be selected from the group consisting of (meth)acrylates, polyurethanes, polyesters, polyimides, polyamides, epoxies, polystyrenes, silicone containing materials, and fluorinated materials. Exemplary (meth)acrylates include (meth)acrylated urethanes, (meth)acrylated epoxies, (meth)acrylated polyesters, (meth)acrylated(meth)acrylics, (meth)acrylated silicones, (meth)acrylated polyethers, (meth)acrylated polyethers, vinyl(meth)acrylates, and (meth)acrylated oils. Exemplary oligomers include aliphatic in that aliphatic materials tend to have good weatherability properties. Because aromatic constituents of oligomers generally tend to have poor weatherability and/or poor resistance to light, aromatic constituents are generally limited to less than 5 percent by weight, for example less than 1 percent by weight, relative to the total weight of the one or more oligomers. For outdoor applications where durability and weatherability are important, the one or more oligomers may comprise (meth)acrylates and polyurethanes, and they may comprise straight chained, branched and/or cyclic aliphatic and/or heterocyclic functionality.

Exemplary (meth)acrylates include those that have reactive pendant or terminal (meth)acrylic acid groups capable of polymerizing. Examples of commercially available (meth)acrylated acrylics include those known by the trade designations EBECRYL 745, 754, 767,1701, and 1755 (UCB Radcure Inc., Smyrna, Ga.). Other oligomers include those available under the trade designations EL V ACITE 2014 (ICI Acrylics, Inc., Wilmington, Del.); JONCRYL 587 (S. C. Johnson, Racine, Wis.); and ACRYLOID B series and PARALOID B series such as P ARALOID B-60 (Rohm. & Haas Co., Philadelphia, Pa.).

Exemplary polyurethanes include those described in U.S. Pat. No. 6,534,128, entitled INKS AND OTHER COMPOSITIONS INCORPORATING LOW VISCOSITY, RADIATION CURABLE, POLYESTER URETHANE OLIGOMER, the disclosure of which is incorporated herein by reference. These polymerizable, urethane oligomers are generally characterized by atypically low viscosity characteristics, have a relatively high urethane content, are very economical to manufacture, and are compatible with a wide range of porous and nonporous substrates.

Other exemplary oligomers include (meth)acrylated aliphatic urethanes and (meth)acrylated aliphatic polyesters which are di(meth)acrylate esters of hydroxy terminated isocyanato (—NCO) extended aliphatic polyesters or aliphatic polyethers. (Meth)acrylated aliphatic polyesters are the reaction products of (meth)acrylic acid with an aliphatic dibasic acid/aliphatic diol-based polyester. Examples of commercially available (meth)acrylated aliphatic urethanes and polyesters include those known by the trade designations PHOTO MER (Henkel Corp. of Hoboken, N.J.).; EBECRYL 284,810,4830,8402,1290,1657, 1810,2001,2047,230,244,264,265,270,4833,4835, 4842, 4866, 4883, 657, 770, 80, 81, 811,812,83,830,8301,835,870,8800,8803,8804 (UCB Radcure Inc. of Smyrna, Ga.); SARTOMER CN series CN964 B-85, CN292, CN704, C 816, CN817, CN818, CN929, CN94413-85, CN945A-60, CN945B-85, CN953, CN961, CN962, CN963, CN 965, CN966, CN968, CN980, CN981, CN982, CN983, CN984, CN985 (Sartomer Co. of Exton, Pa.); ACTILANE (Akcross Chemicals of New Brunswick, N.J.); and UVITHANE (Morton International of Chicago, Ill.).

The one or more oligomers may be multifunctional in that they have two, three, four, etc. polymerizable groups may be used to crosslink the polymerizable components. For example, multifunctional oligomers may include isocyanate crosslinkers that undergo reaction with pendant hydroxyl groups to form polyurethanes.

Multifunctional oligomers may be incorporated into the polymerizable composition to enhance one or more properties of the polymerized film that forms after printing and curing, including crosslink density, hardness, mar resistance, or the like. If one or more of such multifunctional oligomers are present, the polymerizable composition may comprise from 0.5 to 50, for example 0.5 to 35, and in specific embodiments from 0.5 to 25 percent by weight of such materials. Examples of such higher functional, polymerizable monomers include ethylene glycol di(meth)acrylate, hexanediol di(meth)acrylate, triethylene glycol di(meth)acrylate, tetraethylene glycol di(meth)acrylate, trimethylolpropane tri(meth)acrylate, ethoxylated trimethylolpropane tri(meth)acrylate, glycerol tri(meth)acrylate, pentaerythritol tri(meth)acrylate, pentaerythritol tetra(meth)acrylate, and neopentylglycol di(meth)acrylate, combinations of these, and the like.

In general, the types and amounts of the one or more monomers and the one or more oligomers may be selected such that they provide viscosity control, reduced shrinkage upon polymerization, durability, flexibility, adhesion to porous and nonporous substrates, outdoor weatherability, and/or the like. Other factors include the intended use of the ink, the nature of the polymerizable composition, the nature of the oligomers, the molecular weight of the oligomers, and the like. As general guidelines, the inks may include from 0.1 to 50 percent by weight of oligomers, wherein oligomers may comprise from 0.1 to 50, for example from 15 to 40, percent by weight of the polymerizable composition.

For example, in order to promote hardness and abrasion resistance of the printed feature, monomers having high Tg's may be used; monomers having high Tg's are those whose homopolymers have a Tg of at least about 50° C., for example at least about 60° C., and in specific embodiments at least about 75° C. When used, high Tg monomers may constitute 0.5 to 50, for example 0.5 to 40, and in specific examples 0.5 to 30, percent by weight of the polymerizable composition. Such monomers have at least one alicyclic and/or heterocyclic group. Isobornyl(meth)acrylate is a specific example; the homopolymer of isobornyl acrylate has a Tg of 88° C. The monomer itself has a molecular weight of 208 g/mole, exists as a clear liquid at room temperature, has a viscosity of 9 cP at 25° C., has a surface tension of 31.7 mN/m at 25° C., and has excellent compatibility with many types of oligomers.

Monomers and oligomers that promote adhesion to a substrate both before and especially after polymerization may be used. These adhesion promoting components cause the unpolymerized and/or polymerized ink to have higher adhesion to the desired substrate as compared to an otherwise identical formulation lacking such adhesion promoting components. Adhesion promoting components may diffuse into the substrate to form a physical lock when polymerized, and they may have a measurable diffusion coefficient into the substrate. One such class of monomers comprises one or more (meth)acrylate moieties and one or more alkoxy and/or polyalkoxy moieties.

Exemplary adhesion promoting components include monomers having an adhesion score of at least about 50, for example at least about 80, and in specific embodiments at least about 95, when measured according to ASTM D 3359-95A Standard Test Methods for Measuring Adhesion by Tape Test, Method B. When used, the adhesion-promoting component may comprise for example 0.5 to 50, and in specific embodiments 0.5 to 40, percent by weight of the polymerizable composition.

For exemplary monomers with adhesion promoting characteristics, monomers having low Tg's may be used; monomers having low Tg's are those whose homopolymers have a Tg of less than about 40° C., for example less than about 10° C., and in specific embodiments less than about −10° C. Monomers comprising at least one heterocyclic group and at least one (meth)acrylate group are examples. Tetrahydrofurfuryl acrylate is a specific example; it is a clear liquid at room temperature, has a viscosity of 6 cP at 25 ° C., a surface tension of 36.1 mN/m at 25° C., a Tg of −28° C., and a molecular weight of 156 g/mole.

Monomers comprising one or more (meth)acrylate moieties and one or more alkoxy and/or polyalkoxy groups tend to provide good flexibility, low shrinkage, and impact strength when polymerized. However, the alkoxy or polyalkoxy groups may have a tendency to oxidize over time, which could impair the performance of the printed feature. Oxidation particulary occurs when the alkoxy or polyalkoxy groups become part of the main chain of the polymer backbone when the polymerizable compositon is polymerized. The resulting oxidized polymer components cause the printed feature to appear yellow. Generally, no more than about 30 percent by weight of such alkoxylated monomers may be used. Generally, it is better if the alkoxy or polyalkoxy groups are pendant groups which have less of an impact upon bulk polymer properties than does oxidation of main chain alkoxylated functionality.

An exemplary alkoxylated monomer is 2-(2ethoxyethoxy)ethyl acrylate. This monomer is a clear liquid at room temperature and has a viscosity of 6 cP at 25° C., a surface tension of 32.4 mN/m at 25° C., and is slightly polar. A homopolymer of this monomer has a Tg of −54° C.

The polymerizable composition may comprise 10 to 40 percent by weight of a high Tg component (for example isobornyl(meth)acrylate), 15 to 50 percent by weight of an adhesion promoting component (for example a combination of 1 to 20 percent by weight of 2-(2-ethoxyethoxy)ethyl(meth)acrylate per 1 to 20 percent by weight of tetrahydrofurfuryl(meth)acrylate), 5 to 10 percent by weight of a gloss component (for example N-vinylcaprolactam), 5 to 20 percent by weight of a multifunctional polymerizable monomer (for example 1,6- hexanediol di(meth)acrylate), and 5 to 20 percent by weight of the low surface tension component (for example isooctyl(meth)acrylate).

The polymerizable composition may comprise 1 to 10 percent by weight of an alkoxylated (meth)acrylate per 5 to 15 percent by weight of a heterocyclic (meth)acrylate. For example, the polymerizable composition may comprise 2-(2-ethoxyethoxy)ethyl(meth)acrylate and tetrahydrofurfuryl(meth)acrylate.

Monomers and oligomers that promote good initial gloss and good gloss retention over time may be used in the polymerizable composition. Such monomers and oligomers are those that when homopolymerized and cast as a film, have a 60° gloss of at least 70, for example at least 90, when measured according to ASTM D 523 Standard Test Method for Specular Gloss. When a gloss component is used, the polymerizable composition may comprise 0.5 to 30, for example 0.5 to 15, and in specific embodiments 0.5 to 10, percent by weight of the gloss component. Monomers that are solids at room temperature are also useful; although solids by themselves, such monomers tend to be readily soluble in one or more of the other monomers constituting the polymerizable composition. A specific exampl is N-vinyl caprolactam. This monomer is a solid up to about 34° C., has a viscosity of 2.88 cP at 50° C., and a flash point of 114° C. However, gloss components such as N-vinyl caprolactam have poor weathering performance, and graphics made from inks containing N-vinyl caprolactam show poor exterior weathering performance. Therefore it is desirable that the inks used in outdoor applications contain no gloss components, for example, no N-vinyl caprolactam.

In some instances, one or more monomers incorporated into the polymerizable composition may have beneficial properties in one regard, yet may have poor wetting characteristics in terms of being able to wet a wide range of different kinds of porous and nonporous substrates. Tetrahydrofurfuryl acrylate is a good example of this. This monomer has excellent adhesive characteristics, but limited wetting characteristics. Accordingly, in such instances it may be desirable to incorporate one or more enhanced wetting components into the polymerizable composition whose presence causes the ink to have better wetting properties for the desired substrates as compared to an otherwise identical composition lacking such a component. The enhanced wetting component may comprise one or more monomers having a surface tension of about 30 mN/m or less. Other enhanced wetting components comprise at least one (meth)acrylate group and at least one aliphatic group that is straight-chained or branched. A specific example is isooctyl acrylate. This monomer is a clear liquid at room temperature, has a molecular weight of 184 g/mole, and has a surface tension of 28 mN/m.

An exemplary polymerizable composition comprises 30 to 50 percent by weight of a high Tg component (for example isobornyl (meth)acrylate), 30 to 50 percent by weight of an adhesion promoting component (for example 2-(2 ethoxyethoxy)ethyl(meth)acrylate and/or tetrahydrofurfuryl(meth)acrylate), and 5 to 15 percent by weight of a multifunctional polymerizable monomer (for example 1,6-hexanediol di(meth)acrylate).

The inks prepared according to the method disclosed herein may comprise a photoinitiator that generates, upon exposure to actinic radiation, an active species such as free radicals, cations, protons (i.e. an acid), or anions. Examples of photoinitiators include benzophenone, benzoin ether, and acylphosphin, such as those sold under the trade designations IRGACURE and DAROCUR (Ciba-Geigy Corp. of Ardsey, N.Y.). Other photoinitiaters include triazines, and iodonium and sulfonium compounds optionally with a sensitizer such as an anthraquinone. Suitable sources of actinic radiation include mercury lamps, xenon lamps, carbon arc lamps, tungsten filament lamps, lasers, electron beam energy, sunlight, and the like.

The inks prepared according to the method disclosed herein may comprise one or more thermal initiators that generate, upon exposure to heat or infrared radiation, an active species that results in polymerization of the inkjet ink. In addition, accelerated particles such as electron beam radiation may be used to polymerize the ink. When used, the photoinitiators and/or the thermal initiators may be present in the millbase or in the polymerizable composition, or they may be added to the ink after the two are combined.

The amount of radiation used depends upon a number of factors, such as the types and amounts of the components in the ink, the particular radiation source, printing speed, the distance between the radiation source and the printed feature, the color of the printed feature, and the amount of ink to be polymerized. As general guidelines, actinic radiation typically involves a total energy exposure from 0.1 to 10 J/cm², and electron beam radiation typically involves a total energy exposure in the range of from less than 1 megarad to 100 megarads or more, for example 1 to 10 megarads. Exposure times may be from less than about 1 second up to 10 minutes or more. Exposure may occur in air or in an inert atmosphere such as nitrogen.

The pigment in the ink may absorb part of the incident radiation, depleting the available energy to activate the photoinitiator. This will slow down the polymerization rate and may result in poor through and/or surface polymerization of the printed ink. Generally, therefore, a mixture of photoinitiators is used in order to provide both surface and through polymerization.

The amount of photoinitiator(s) used in the ink typically varies between 1 and 15 percent by weight, for example between 3 and 12 percent by weight, and in specific embodiments between 5 and 10 percent by weight, relative to the total amount of the inkjet ink.

A variety of other components may be incorporated either into the millbase, the polymerizable composition, and/or the ink already comprising the millbase and the polymerizable composition. For example, polymers having a molecular weight of greater than 100,000 g/mol may be used. The polymers may or may not have polymerizable groups, and they may comprise from 0.1 to 30, for example 5 to 20, percent by weight of the polymerizable composition. Other components include slip modifiers, thixotropic agents, foaming agents, anti-foaming agents, flow or other rheology control agents, waxes, oils, plasticizers, binders, antioxidants, photoinitiator stabilizers, electrical conductive agents, fungicides, bactericides, organic and/or inorganic filler particles, leveling agents, opacifiers, antistatic agents, dispersants, and the like.

Co-initiators and amine synergists can also be used in the ink in order to improve the polymerization rate; examples include isopropylthioxanthone, ethyl 4(dimethyl amino)benzoate, 2-ethylhexyl dimethylaminobenzoate, and dimethylaminoethyl methacrylate.

To enhance the durability of a printed image graphic, especially in outdoor environments exposed to sunlight, heat stabilizers; UV light stabilizers; and free radical scavengers may be used. Heat stabilizers are commonly used to protect the resulting image graphic against the effects of heat and are commercially available under the trade designations MARK V 1923 (Witco Corp. of Greenwich, Conn.); SYNPRON 1163, Ferro 1237 and Ferro 1720 (Ferro Corp., Polymer Additives Div., Walton Hills, Ohio), and can be present in amounts ranging from 0.02 to 0.15 percent by weight. UV light stabilizers are commercially available under the trade designations UVINOL 400 (a benzophenone type UV-absorber sold by BASF Corp. of Parsippany, N.J.); Cyasorb UV 164 from Cytec Industries, West Patterson, N.J.; and TINUVIN 900 and/or 1130 (Ciba Specialty Chemicals, Tarrytown, N.Y.) and can be present in amounts ranging from 0.1 to 5 percent by weight of the ink. Free-radical scavengers include hindered amine light stabilizers (HALS), hydroxylamines, sterically hindered phenols, and the like. Commercially available HALS include TINUVIN 292 (Ciba Specialty Chemicals, Tarrytown, N.Y.) and CYASORB UV3581 (Cytec Industries, West Patterson, N.J.); they may be present in an amount of from 0.05 to 2.5 percent by weight of the ink.

In some applications, such as certain forms of inkjet printing, substantially nonconductive inks are required for good performance. For such applications, inkjet imks of the present invention generally are substantially nonconductive.

In other applications, such as certain forms of inkjet printing, the inkjet inks may need to be conductive, so that they have, for example, electrical resistivity below 5000 ohm-cm, or below about 500 ohm-cm. Conductive agents may be used to adjust the conductivity; examples include dimethylamine hydrochloride, diethylamine hydrochloride, lithium nitrate, and hydroxylamine hydrochloride, typically present in amounts up to about 2 percent by weight.

The inkjet inks made according to the methods disclosed herein may be inkjet printed (inkjetted) onto a variety of substrates such as wood, metal, paper, woven or nonwoven fabrics, resin-coated paper, foil, polymer articles, polymer films, and the like. The inkjet inks may be used to form graphic elements, text items, indicia, continuous layers, bar codes, or other features.

The inkjet inks made according to the methods disclosed herein are highly compatible with both porous and nonporous substrates. However, they are particularly useful for non-porous substrates in that they produce images with improved gloss. The compatibility with nonporous materials allows these inks to be applied onto a wide range of nonporous polymer films. Nonlimiting examples of such films include single and multi-layer constructions of acrylic-containing films, poly(vinyl chloride)-containing films, (for example, vinyl, plasticized vinyl, reinforced vinyl, vinyl/acrylic blends), urethane-containing films, melamine-containing films, polyvinylbutyral-containing films, and multi-layered films having an image reception layer comprising an acid- or acid/acrylate modified ethylene vinyl acetate resin, as disclosed in U. S. Pat. No. 5,721,086 (Emslander et al.) or having an image reception layer comprising a polymer comprising at least two monoethylenically unsaturated monomeric units, wherein one monomeric unit comprises a substituted alkene where each branch comprises from 0 to 8 carbon atoms and wherein one other monomeric unit comprises a (meth)acrylic acid ester of a nontertiary alkyl alcohol in which the alkyl group contains from 1 to 12 carbon atoms and can include heteroatoms; in the alkyl chain and in which the alcohol can be linear, branched, or cyclic in nature.

Useful films include those that have two major surfaces with one surface being able to receive an inkjet image graphic of the present invention and the other major surface being adhered to a field of pressure sensitive adhesive. Usually, the field of adhesive on one major surface is protected by a release liner. Such films can be clear, translucent, or opaque. Such films can be colorless or solid color or a pattern of colors. Such films can be transmissive, reflective, or retroreflective. Commercially available films known to those skilled in the art include the multitude of films available from 3M Company under the trade designations PANAFLEX, NOMAD, SCOTCHCAL, SCOTCHLITE, CONTROL TAC, and CONTROL TAC-PLUS.

Compatibility of the inkjet inks with a wide variety of porous and nonporous substrates can be accomplished by appropriate selection of the polymerizable components and the organic solvent. The polymerizable ink images exhibit good adhesion to non-porous substrates, especially those used in vinyl marking films such as 3M Controltac 180-10 (available from 3M Company, Maplewood, Minn.) and retroreflective sheeting topfilms. ASTM D 3359-95A Standard Test Methods for Measuring Adhesion by Tape Test, Method B can be used to measure adhesion.

The inkjet inks may have a wide range of elongation characteristics depending upon the intended use. For example, they may have an elongation of at least about 20%, such as at least about 50%, in some embodiments at least about 300% and in specific embodiments greater than 300%. Polymerized inks with elongation characteristics greater than about 50% are used to reduce stress cracks, improve toughness, and improve weatherability of the printed graphic (printed, dried and polymerized ink on the substrate). Polymerized inks with good elongation characteristics are useful to prevent the polymerized ink layer from delaminating from the underlying substrate (on which it has been printed) due to stretching or other dimensional change of the substrate. Such elongation also allows the polymerized inks to remain adhered to the substrate without cracking or delamination when the substrate is conformed to contoured surfaces, such as the panels and rivets of truck traitors, other vehicles or other uneven application surfaces. In the practice of the present invention, elongation of a polymerized ink refers to the maximum elongation at break determined in accordance with ASTM Test Method D 3759.

In many embodiments, the polymerized inks, excepting those inks that contain opaque colorants such as carbon black, titania (TiO₂), or organic black dye, are transparent when measured according to ASTM 810 Standard Test Method for Coefficient of Retroreflection of Retroreflective Sheeting. That is, when coated onto retroreflective substrates, the visible light striking the surface of such films is transmitted through to the retroreflective sheeting components. This property makes such inks useful for outdoor signing applications, in particular traffic control signing systems.

In some embodiments, the polymerized inks also resist marring when subjected to moderate abrasion. A useful method for evaluating abrasion resistance is ASTM D 4060 Standard Test Method for Abrasion Resistance of Organic Coatings by Taber Abrader. When monitored by percent retention of gloss or retroreflectivity over the abraded surfaces, the polymerized inks of some embodiments show excellent abrasion resistance relative to an screen printing ink standards.

### EXAMPLES

The following abbreviations are used throughout the examples:
BAYER YELLOW Y5688 is a trade designation for a yellow pigment available from Bayer Corp. of Pittsburgh, Pa.
RT-343-D magenta pigment is a trade designation for magenta pigment available from Ciba Specialty Chemicals of Tarrytown, N.Y.
249-1284 CYAN 15:3 pigment is a trade designation for cyan pigment available from Sun Chemical Corp. of Fort Lee, N.J.
LAMPBLACK LB 101 PIGMENT I is a trade designation for black pigment available from Pfizer Inc. of New York, N.Y.
IRGACURE 819 is a trade designation for bis-(2,4,6 trimethylbenzoyl)phenylphosphine oxide a photoinitiator available from Ciba Specialty Chemicals of Tarrytown, N.Y.
SOLSPERSE 5000 and SOLSPERSE 32000 are trade designations for dispersants available from Zeneca Inc of Wilmington, Del.
SARTOMER CN 981 is an aliphatic urethane acrylate oligomer available from Sartomer Co. of Exton, Pa.
EBECRYL 80 is an amine modified polyether acrylate available from from UCB Chemicals of Smyrna, Ga.
Tetrahydrofurfuryl acrylate (THFA), isobornyl acrylate and isooctyl acrylate are available from Sartomer Co. of Exton, Pa.
MINI-ZETA is a trade designation for a bead mill available from Netzsch Inc. of Exton, Pa.
CGS-50 is a 2-ethoxybutyl acetate available from 3M Company of Maplewood, Minn.
SILQUEST A174 is a UV-polymerizable silane available from Osi Specialties, Inc. of Danbury, Conn.

A cyan millbase was made as follows: To 2-ethoxybutyl acetate (CGS-50) (55 percent by weight) were added SOLSPERSE 5000 (3 percent by weight) and SOLSPERSE 32000 (15 percent by weight), and the dispersants were dissolved by mixing. The cyan pigment (Sun Blue 249-1284 Cyan 15:3 Pigment) (27 percent by weight) was then added and incorporated by mixing with a rotor-stator mixer. The dispersion was then milled using a Netzsch MINI-ZETA bead mill using 0.5 mm zirconia media. The dispersion was milled for 70 minutes.

A magenta millbase was made as follows: To 2-ethoxybutyl acetate (CGS-50) (55 percent by weight) was added SOLSPERSE 32000 (12 percent by weight), and the dispersant was dissolved by mixing. The magenta pigment (RT-343-D) (33 percent by weight) was then added and incorporated by mixing with a rotor-stator mixer. The dispersion was then milled using a Netzsch MINI-ZETA bead mill using 0.5 mm zirconia media. The dispersion was milled for 90 minutes.

A yellow millbase was made as follows: To 2-ethoxybutyl acetate (CGS-50) (50 percent by weight) was added SOLSPERSE 32,000 (16 percent by weight), and the dispersant was dissolved by mixing. The yellow pigment (Y-5688) (33 percent by weight) was then added and incorporated by mixing with a rotor-stator mixer. The dispersion was then milled using a Netzsch MINIZETA bead mill using 0.5 mm zirconia media. The dispersion was milled for 70 minutes.

A black millbase was made as follows: To 2-ethoxybutyl acetate (CGS-50) (50 percent by weight) was added SOLSPERSE 32000 (15 percent by weight), and the dispersant was dissolved by mixing. The black pigment (RAVEN available from Columbian Chemicals Company of Marietta, Ga.) (35 percent by weight) was then added and incorporated by mixing with a rotor-stator mixer. The dispersion was then milled using a Netzsch MINI-ZETA bead mill using 0.5 mm zirconia media. The dispersion was milled for 45 minutes.

Polymerizable inks were prepared by combining each of the millbases described above with other components as described in Table 1.

TABLE 1

| Component | | | | |
|---|---|---|---|---|
| (percent by weight) | Cyan | Magenta | Yellow | Black |
| CGS-50 | 5.23 | 11.00 | 3.79 | 5.00 |
| SOLSPERSE 5000 | 0.29 | 0 | 0 | 0 |
| SOLSPERSE 32000 | 1.43 | 2.40 | 1.24 | 1.50 |
| Pigment | 2.57 | 6.60 | 2.48 | 3.50 |
| SARTOMER CN 981 | 10.07 | 8.67 | 10.33 | 10.00 |
| EBECRYL 80 | 10.07 | 8.67 | 10.33 | 10.00 |
| Isooctyl acrylate | 22.65 | 19.50 | 23.25 | 22.50 |
| Isobornyl acrylate | 22.65 | 19.50 | 23.25 | 22.50 |
| THFA | 10.07 | 8.67 | 10.33 | 10.00 |
| SILQUEST A174 | 5.00 | 5.00 | 5.00 | 5.00 |
| Benzophenone | 5.00 | 5.00 | 5.00 | 5.00 |
| IRGACURE 819 | 5.00 | 5.00 | 5.00 | 5.00 |

The polymerizable inks were printed using a Rastergraphics Arizona piezo inkjet printer (Rastergraphics Inc. of San Jose, Calif.) onto vinyl (3M Company of Maplewood, Minn. as 3M CONTROLTAC PLUS™ GRAPHIC SYSTEM 180-10 vinyl film). During printing, the image was scanned with a portable medium pressure mercury lamp (A CONTROLCURE PORTABLE 2″ CURING SYSTEM available from UV Process Supply, Inc. of Chicago, Ill.) held manually about six inches above the imge and the portable lamp unit was scanned across the web traversing the freshly printed image behind the print head carriage giving high quality images with excellent gloss and deep color.

Various modifications and alterations to the invention will become apparent to those skilled in the art without departing from the scope and spirit of the invention. It should be understood that the invention is not intended to be unduly limited by the illustrative embodiments and examples set forth herein, and that such examples and embodiments are presented by way of example only with the scope of the invention intended to be limited only by the claims set forth herein as follows.

What is claimed is:

1. A method of making an inkjet ink, comprising
milling a pigment in an organic solvent to form a millbase, wherein the millbase is substantially free of polymerizable components; and
mixing a polymerizable composition with the millbase to form a polymerizable ink.

2. The method of claim 1 wherein the inkjet ink has a viscosity less than about 50 cP at 25° C.

3. The method of claim 1 wherein the inkjet ink has a viscosity less than about 30 cP at 25° C.

4. The method of claim 1 wherein the organic solvent has a surface tension of from about 20 mN/m to about 50 mN/m.

5. The method of claim 1 wherein the organic solvent has surface tension at least 2 mN/m less than the surface tension of the polymerizable composition.

6. The method of claim 1 wherein the organic solvent comprises one or more isoalkyl esters selected from the group consisting of isohexyl acetate, isoheptyl acetate, isooctyl acetate, isononyl acetate, isodecyl acetate, isododecyl acetate, and isotridecyl acetate.

7. The method of claim 1 wherein the organic solvent comprises an ether.

8. The method of claim 1 wherein the organic solvent is present in an amount of less than about 15 percent by weight, relative to the total weight of the inkjet ink.

9. The method of claim 1 wherein the organic solvent is present in an amount of less than about 12 percent by weight, relative to the total weight of the inkjet ink.

10. The method of claim 1 wherein the polymerizable composition comprises one or more monomers and/or one or more oligomers.

11. The method of claim 10 wherein the one or more monomers and/or the one or more oligomers are polymerizable by addition polymerization.

12. The method of claim 10 wherein the one or more monomers is selected from the group consisting of styrenes, vinyls, (meth)acrylamides, (meth)acrylates, epoxides, (meth)acrylonitriles, and unsaturated anhydrides.

13. The method of claim 10 wherein the one or more oligomers is selected from the group consisting of (meth)acrylates, polyurethanes, polyesters, polyimides, polyamides, epoxies, polystyrenes, silicone containing materials, and fluorinated materials.

14. The method of claim 10 wherein the one or more oligomers comprises less than 5 percent by weight of aromatic constituents, relative to the total weight of the one or more oligomers.

15. The method of claim 10 wherein the one or more oligomers comprises straight chain, branched and/or cyclic aliphatic and/or heterocyclic functionality.

16. The method of claim 1 wherein the millbase further comprises a photoinitiator.

17. The method of claim 1 wherein the polymerizable composition comprises a photoinitiator.

18. The method of claim 1 wherein the inkjet ink comprises a thermal initiator.

19. The method of claim 1 wherein milling comprises ball milling.

20. The method of claim 1 further comprising filling an inkjet cartridge with the ink.

21. The method of claim 19 further comprising printing the ink onto a substrate.

22. The method of claim 20 further comprising applying actinic radiation and drying the ink.

23. The method of claim 20 further comprising applying heat or infrared radiation to polymerize the ink.

24. The method of claim 20 further comprising applying electron beam radiation to polymerize the ink.
